(19) United States
(12) Patent Application Publication
(10) Pub. No.: US 2006/0129336 A1
(43) Pub. Date: Jun. 15, 2006

(54) Human machine interface for instruments and method to configure same

(75) Inventors: John Pretlove, Sandvika (NO); Charlotte Skourup, Drammen (NO); Juha Kestila, Helsinki (FI); Geoff Selley, St. Neots (GB); Martin Ashford, St. Neots (GB); Steve Eeles, St. Neots (GB); Sean Keeping, St. Neots (GB); Roger Arnold, St. Neots (GB)

Correspondence Address: VENABLE LLP, P.O. BOX 34385, WASHINGTON, DC, 20045-9998, US

(73) Assignee: ABB Research Ltd., Zurich (CH)

(21) Appl. No.: 11/217,365

(22) Filed: Sep. 2, 2005

Related U.S. Application Data
(60) Provisional application No. 60/606,516, filed on Sep. 2, 2004.

(51) Int. Cl. G01F 1/00

(52) U.S. Cl. 702/45; 702/122

(57) ABSTRACT

A measuring instrument with a human-machine interface comprising a visual display and selection means associated with the visual display, a method to configure using the visual display and a plurality of selectors or buttons, and a computer program and graphic user interface for carrying out the method.

### CROSS-REFERENCE TO RELATED APPLICATIONS

This application claims the benefit of provisional application U.S. 60/606,516, filed Sep. 2, 2004.

### TECHNICAL FIELD

The present invention is concerned with a control interface for industrial devices and in particular for control of measurement instruments and for control of drives for electric motors and actuators. In particular it is concerned with a control interfaces comprising an improved human-machine interface (HMI) for measuring instruments used in industrial applications, process industry applications, commercial and utility installations and in electrical power generation, transmission or distribution applications.

### BACKGROUND ART

Many electric motors used in industrial and commercial processes and buildings are controlled by soft starter equipment. Soft starters are used to start a motor and stop a motor in a desired manner, such as to eliminate electrical surges in the electrical supply and/or overheating in the motor. Soft starters are also used to reduce or eliminate mechanical shocks or vibration which might otherwise occur under start/stop conditions causing wear and damage to the pumps, fans etc. driven by the motors. A soft starter typically measures the input current and/or voltage of the motor and regulates the input current and/or voltage received by the motor to achieve a desired start or stop performance.

Electrically powered actuators, servomotors, solenoids and so on are also used to move moving parts of control equipment such as gate valves, butterfly valves, baffles in process equipment and/or breaker arms of circuit breakers, protection switchgear, actuators for transformer or reactor equipment such as tap changers and similar. The drive controller generally requires configuration to suit the circumstances of each application. During configuration the parameters influencing in particular the starting current, and also factors such as the speed, start up time or maximum input current etc. have to be selected or set up in the drive controller according to what kind of start or stop is desired for the motor and/or the equipment it is driving. Drive controllers may comprise many features and functions, and the configuration is often therefore somewhat difficult and time consuming.

For example, although AC motors are used all over the world, the AC supply frequency may be either 50 Hz or 60 Hz and the range of operating currents and operating voltages supplied is extensive. Protection against overheating of the semiconductor components is necessary as well as other types of overload protection. In summary, there usually are a great number of factors or parameters that require configuration or selection in order to be able to use a soft starter.

Within instrumentation, there are lots of different devices with a different look and functioning Human-Machine Interface (HMI). Very often, more than one instrumentation device is installed within a plant. It is very hard and not intuitive to remember how to interact with each single device. Examples are that the interaction buttons may have different functionality, the same interaction button may be located at different places and the same function may be named differently from the various devices. A set of devices from the same supplier with a complete different look and varying functionality is not efficient. The confusion different interfaces may possibly cause failure situations due to an in-attentive user using an interface as though it were for with another device, but because of inconsistency the function is performed wrongly at the current device.

Today's solutions almost provide a different human-machine interface to each device/process to be controlled. They not just look differently, they also behave differently. The functionalities such as navigation, adjusting numbers and presenting data are outlined or designed differently. It is very hard for the user to operate a set of different devices, but that is the reality. The probability that an operator may perform a wrong operation, especially a new operator, increases. Further, it requires more time for the operator to be aware of all his operations and to remember how to navigate, for example, to the monitoring view for the pressure meter. For some devices, the ‘menu’ and ‘exit’ options are located in opposite positions which may cause problems. Another issue is the language used for the options. Even within English, the HMI for the control devices may use different terms for the same option, or even within the same HMI, different terms like ‘back’, ‘return’, ‘undo’ and ‘exit’ may be used for the same function.

Traditionally some interface control buttons have been marked with a pictorial symbol representative of certain functions. However, it may be difficult for an operator to interpret the picture correctly. In addition, a difficulty with this type of design is that the operator must recognise the meaning of the symbols correctly in order to be able to configure and/or operate the instrumentation and the soft starter efficiently. This requires extensive customer support, beginning with comprehensive user manuals in order to configure such control interfaces correctly.

### SUMMARY OF THE INVENTION

The aim of the present invention is to remedy one or more of the above mentioned problems. This and other aims are obtained by a motor controller as defined in the appended claims.

A first aspect of the invention is a human-machine interface for control and configuration of a measuring instrument comprising a visual display and selection means such as switches or buttons associated with the visual display, wherein said visual display comprises means for presenting one or more operational and/or control functions including various parameter settings etc., and said associated selection means comprise hardware and/or software switch means for selecting the one or more operational and/or control functions so displayed and/or navigating to another function or menu option.

This invention describes a method and a system for interacting with a control interface of an industrial device or a measuring instrument. The invention includes a conceptual description of the interface, i.e. consistency of the information presentation and interaction with it. This invention proposes a display and at least four interaction buttons. These four interaction buttons are grouped into two groups; Two soft buttons to control navigation in the display (located horizontally in relation to each other) and two interaction buttons for ‘up/‘down’ functions such as to scroll in a list of several options and to adjust a number. The display should be as small as possible without reducing the understanding of information presented.

This Human-Machine Interface (HMI) for the whole range of instrumentation devices should be consistent and based on the same principles for navigation, functionality, information presentation, terminology and interaction with the underlying industrial device/process.

An innovative element is a consistent way of presenting information and interacting with it for controlling wide range of industrial devices and/or processes.

This invention proposes for example a common Human-Machine Interface (HMI) for instrumentation devices which cover a large family, e.g. meters to measure flow, temperature and pressure. The system and method includes a display to visualise and/or present information and a set of interaction buttons in order to interact with the instrumentation device. Examples of tasks to perform with the proposed HMI include configuration, selecting, navigation, monitoring, alarm handling and wizards/macros. A subset of these interaction buttons may be soft buttons, which means that their functionality varies according to the current visual display functionality, or state of the device, and which task the user is performing. The objective of the proposed HMI is to control an industrial process directly. One HMI device may control one or more devices/processes such as flow, temperature and pressure.

Basically, the interaction buttons comprise four on-screen operation as four buttons. Two buttons are soft buttons which means that the current state within the HMI decides the functionality of these two buttons. Examples for the first button are ‘menu’, ‘select’, whereas functions of the second button may be ‘back’, ‘continue’ and ‘exit’. The two remaining buttons are typically used to navigate up and down either physically for scrolling within the display (navigation) or for adjusting, for example, a number.

Basically, the display should be able to display the current status and various options, all in an easy and intuitive way. Also, the display should have clearly marked exits and/or ‘undo’-like operations so that the user at any time can go one step backwards. The size of the display may vary dependent on the application to control. If information can be presented easily within a two-line display, it should be as small as possible.

A feature of this invention is consistency of presented information. The functionality of the four interaction buttons should follow a predefined standard. In practice, this means that the ‘menu’ choice is preferably always located, for example, as the left soft button. Likewise, navigating up and down in a list of different options should always follow the same rule, for example, the up-button moves the selected option one step up in the list.

The proposed HMI device should be able to be configured to different languages without changing the consistent navigation options and information presentation.

A major advantage of the present invention is that configuration of the instrumentation is considerably more simple to set up and operate. The configuration functions, as well as operation or control functions, are displayed one at a time in plain text and easily understood words on the display. A user simply selects that option or selects another menu or navigation option. This is done by simply selecting a selection means, for example that button amongst the associated selection means, the hardware or software switches or buttons, the relative position of which corresponds to the relative position of the desired option on the display.

Another advantage of the invention is that it may control a plurality of devices such as electric motors or actuators. This means that the control functions enabled by the drive controller are available a plurality of processes or part processes. Operational data such as number of starts, and of lists of standard events as well as lists of alarms, is thus available for a plurality of motor/actuator applications and or processes.

In another aspect of the invention a method is described for configuring drive controller with a HMI according to the invention. The method includes use of information displayed by the visual display and use of the selection means to select a function and/or to navigate to other options.

In another aspect of the invention a computer program is described for carrying out the method or methods according to the invention. In another aspect of the invention a computer program product comprising a computer program for carrying out the method of the invention is described. In another aspect of the invention a computer data signal embodied in a carrier wave is described. In another, further aspect of the invention a graphical user interface is described for displaying configuration for the motor controller and/or operational data for one or more of the electric motors so controlled.

### BRIEF DESCRIPTION OF THE DRAWINGS

A more complete understanding of the method and system of the present invention may be had by reference to the following detailed description when taken in conjunction with the accompanying drawings wherein:

FIG. 1 shows a display of a HMI for a start up display according to an instrumentation embodiment of the invention,

FIGS. 2-6 show the options within the menu when selecting the ‘menu’ with the left soft button,

FIG. 2: Menu option—Device

FIG. 3: Menu option—Alarm

FIG. 4: Menu option—Display

FIG. 5: Menu option—Communication

FIG. 6: Menu—Adjust

FIG. 7: Menu—Adjust—Set 0%

FIG. 8: Menu—Adjust—Set 0%—Edit

FIG. 9: Menu—Adjust—Set 0%

FIG. 10: Menu—Alarm

FIG. 11: Menu—Alarm—Alarm Type

FIG. 13 is an overview of the navigation structure interface,

FIG. 14 is the display of a HMI of FIG. 1 for a start up display and with reference numbers added,

FIG. 15 shows a schematic diagram for connection of a motor controller to a field bus network,

FIG. 16 shows a block diagram of components of a system that are comprised in the soft starter of a motor controller.

### DESCRIPTION OF THE PREFERRED EMBODIMENTS

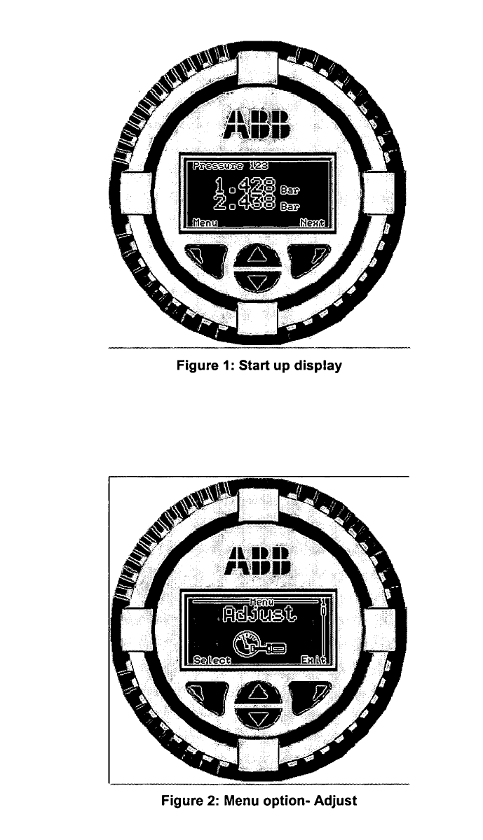

FIG. 1: Opening display or Start up display for an embodiment of the invention, in particular adapted to instruments, instruments for measuring typically physical parameters.

The leftmost and rightmost blue interaction buttons 5 are soft buttons. The functionality of the soft buttons varies dependent on a state of the application displayed. The two interaction/selection/increment buttons in the middle (with the up 6a and down 6b arrow) are typically used for scrolling up and down in a list of different options as well as for adjusting numbers, for example by incrementing a value or part value up or down. The blue “soft” buttons 5a, 5b are programmable to determine which selections may be displayed dependent on what other values or options are displayed on the visual display at the same time; see also more detail about exemplary functions of soft key button described below for each of the left button 5a and right button 5b.

FIG. 2-6 show the options within the menu when selecting the ‘menu’ with the left soft button.

FIG. 2: Menu Option—Adjust

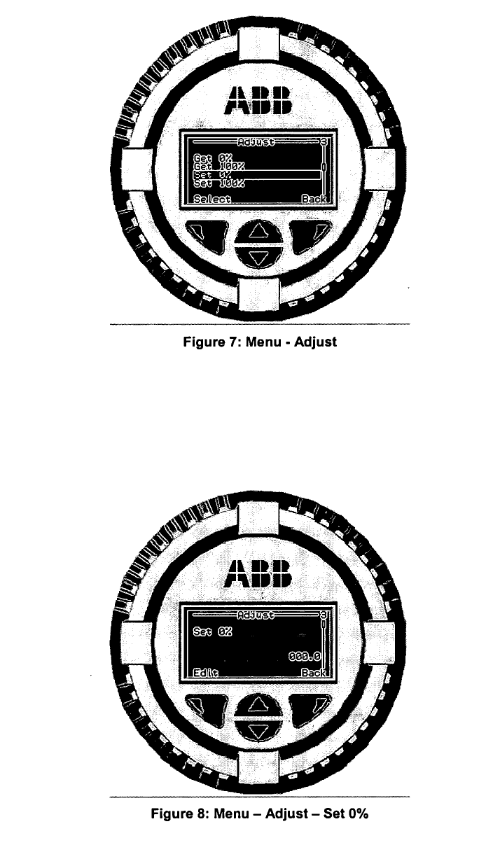

Top right of display shows that Adjust is Item 1 on the menu list. Selecting “Select” activates Adjust options for the instrument, see“Figure 7 for details, Exit from here returns the user to the Opening display

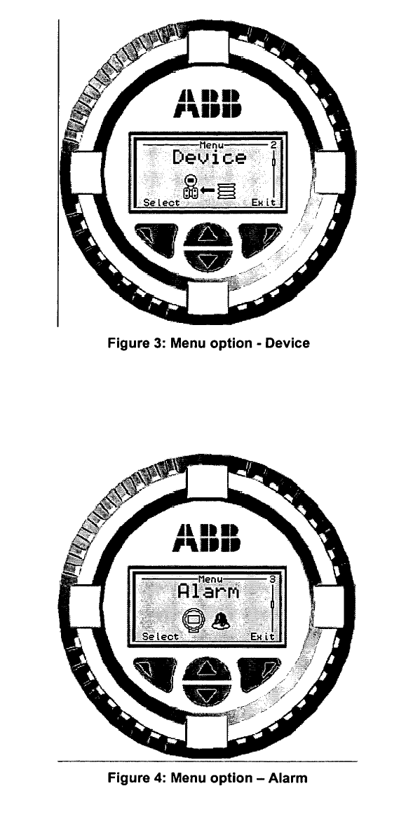

FIG. 3: Menu Option—Device

Top right of display shows that Device is Item 2 on the menu list. Selecting “Select” displays Device options for the instrument, Exit from here returns the user to the Opening display.

FIG. 4: Menu Option—Alarm

Top right of display shows that Alarm is Item 3 on the menu list. Selecting “Select” accesses Alarm options, see alarm state, set alarm, re-set alarms and so on: setting or changing alarms for this instrument, Exit from here returns the user to the Opening display.

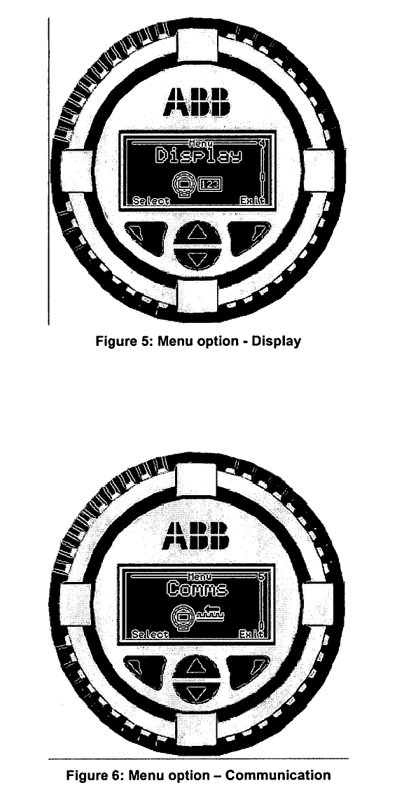

FIG. 5: Menu Option—Display

Top right of display shows that Display is Item 4 on the menu list. Selecting “Select” activates Display options for the instrument, Exit from here returns the user to the Opening display

FIG. 6: Menu Option—Communication

Under ‘menu’, there are five options: Adjust, device, alarm, display and communication. Note how the soft buttons change their function dependent on the selected functionality out of the possible functions of Adjust, device, alarm etc.

For example Selecting ‘adjust’ results in a view with four options (see FIG. 6).

FIG. 7: Menu—Adjust

Further, to adjust ‘Set 0%’, the user pushes ‘Select’ and FIG. 7 illustrates the resulting display. Note here that top right of display shows that Display is Item 4 on the menu list. Selecting “Select” has displayed Adjust for the instrument. Selecting “Back” at lower right of display, will return the user back one step to the Adjust menu option display of FIG. 2

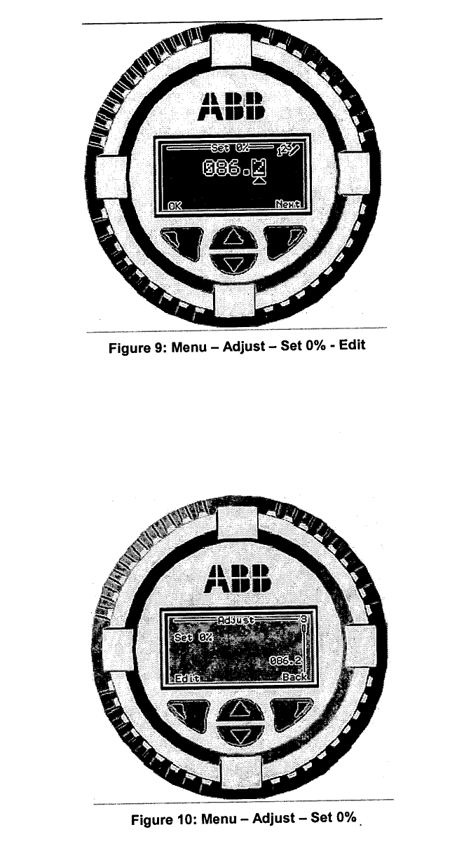

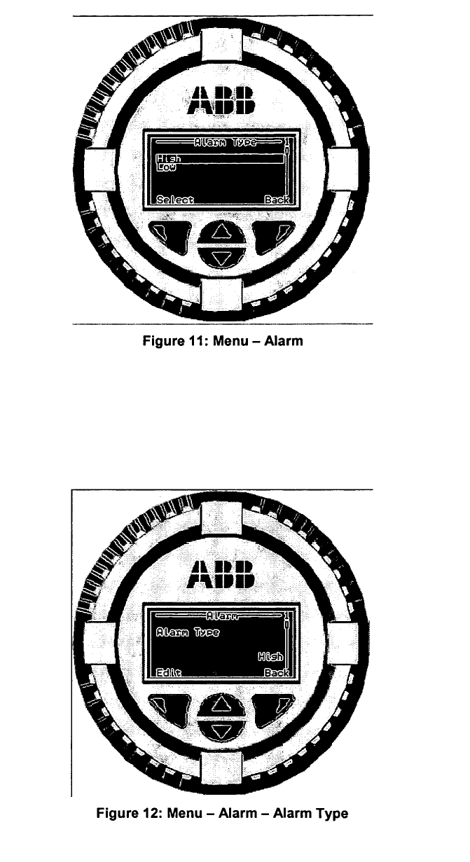

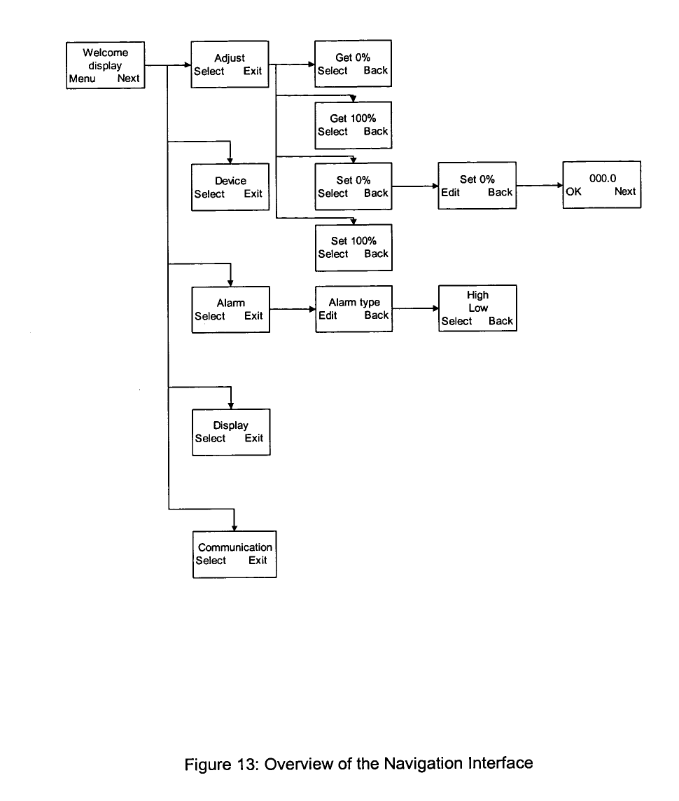

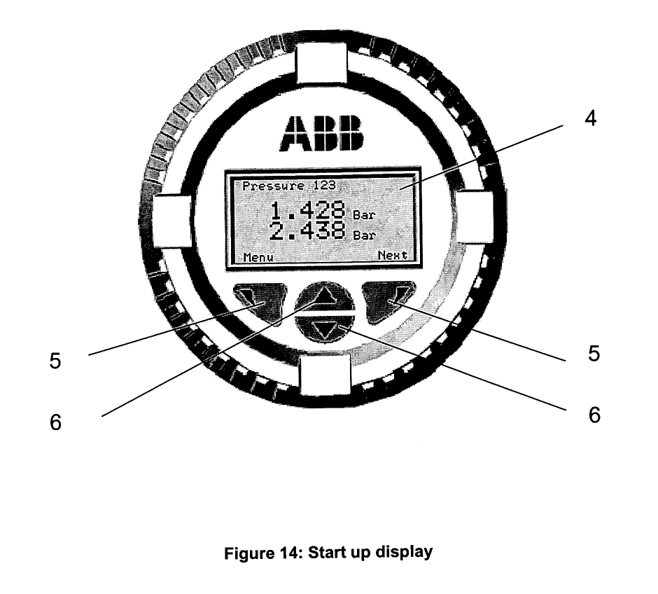

FIG. 8: Menu—Adjust—Set 0%

The user immediately sees the status after setting to 0% which is ‘000.0’. Note here that top right of display still shows Adjust and it that is Item 3 on the menu list. Selecting “Edit” would allow the user to edit this value, see FIG. 9 below, and selecting “Back” at lower right of display, will return the user back one step to the Adjust menu option display of FIG. 2.

FIG. 8 illustrates how the display changes when using the left soft button ‘Edit’. FIG. 12: Menu—Adjust—Set 0%—Edit. The user can now use the ‘up’ and ‘down’ arrows combined with the right soft button to change the setting. FIG. 8 illustrates how the user has edited the value to 86.2.

FIG. 9 shows how the display of FIG. 9 changes when the user has pressed the left ‘OK’ soft button. FIG. 13: Menu—Adjust—Set 0% In the menu structure, the user is now back one level, but can see the status of the adjustment.

Going back to the menu and selecting ‘Alarm’, FIG. 10 illustrates the display. FIG. 11: 14: Menu—Alarm

The user can change between ‘High’ and ‘Low’ using the ‘up’ and ‘down’ keys. Selecting ‘High’ results in the display shown in FIG. 11. FIG. 12: 15 shows a display of Menu—Alarm—Alarm Type

Navigation Structure

First, the user meets a start-up display from where he can go into the menu (this only illustrates an example of how it can be implemented).

Navigation Structure:

Menu
Adjust
   Get 0%
   Get 100%
   Set 0%
      Edit 000.0
   Set 100%
Device
Alarm
   Edit alarm type: High/low
Display
Communication

FIG. 13 is an overview of the navigation structure interface where the flat structure or logic provides access to options such that navigation is confined to a small number of layers. A user can access an option by a minimum number of selection moves. FIG. 13: Overview of the menu navigation structure

Soft Key Buttons

In the given example, the left soft key has the following functions:
Menu
Select
Edit
OK

The right soft key has the following functions in this example:
Next
Exit

Back

Navigation structure for the drives embodiment is also a logic with few levels, like the instrumentation embodiment.

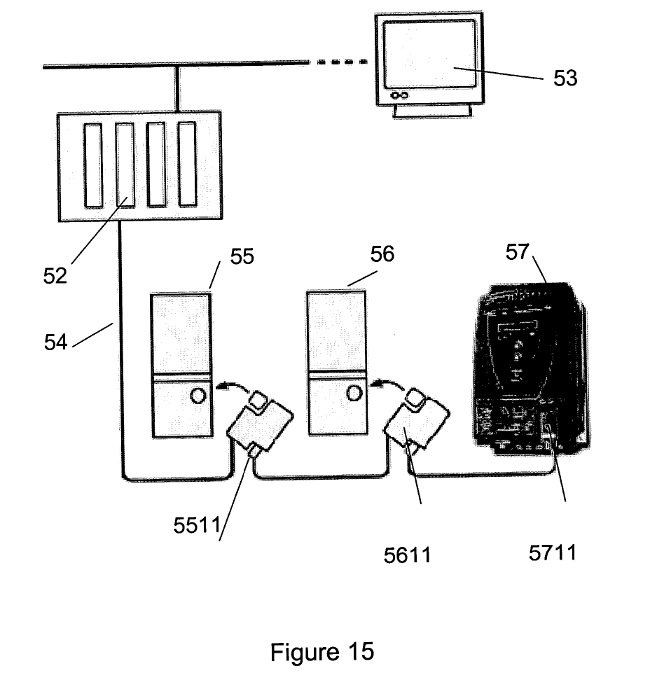

FIG. 15 shows a schematic diagram for connection of a motor controller to a field bus network. The figure shows a data network 51 of a control system and a computer or workstation 53 connected to the control system. The control system comprises a bank of controllers 52, and a field bus 54 to which three of the soft starter motor controllers are connected for digital exchange of data between the motor controllers and the control system. The connection is made by field bus plugs 5511, 5611, 5711 into the field bus socket of the soft starter. In the same way, an instrument with an HMI according to an embodiment of the invention may be connected to a data network. Thus instruments with the HMI may be connected in exactly the same way as the motor controllers 55, 56, 57 using a standard serial and or data port of any other sort, such as a field bus connection.

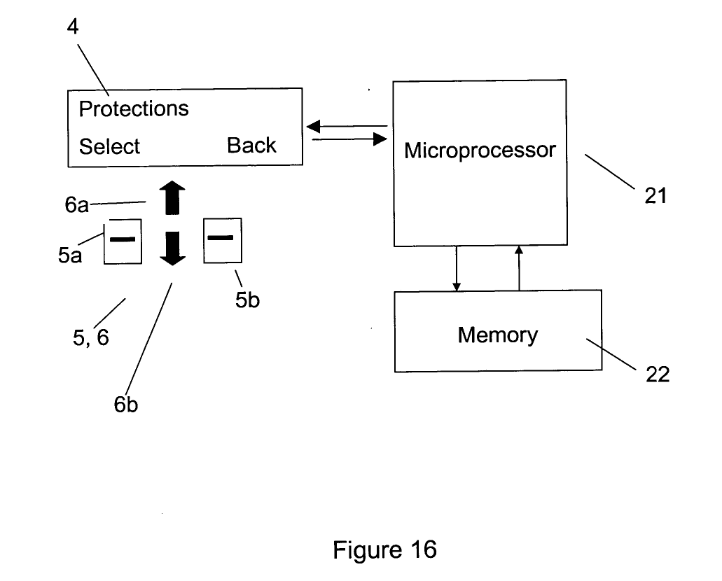

FIG. 16 shows a block diagram of components of a system that is comprised in the soft starter of a motor controller. In the same way, an instrument with an HMI according to an embodiment of the invention may comprises those elements as previously described, and may also comprise a processing means 21, and may also comprise a memory means 22. The functions displayed at the time of selections being made are also displayed by means of the microprocessor, see FIG. 16, so that the selection options available are provided on display means 4 by program means run by the microprocessor 21 and the selection options actually made may be saved in the memory means 22. The display is preferably a LCD (Liquid Crystal Display) but may be any other means, vacuum tube display, plasma screen, pixel display etc and/or including touch sensitive screen materials.

Configuration may also be carried out using wireless means such as a IR or Bluetooth equipped computer, mobile phone or PDA or other mobile computing device. A wireless node (not shown) may be connected to a data port or to the field bus network that the instrument, soft starter or device is connected to via field bus connector. By means of the wireless node connected in some way to the soft starter the soft starter may be configured wirelessly using the same methods as herein described. Any wireless protocol capable of providing reliable transmissions in an industrial environment may be used, including standards or protocols such as Bluetooth, Wireless LAN (WLAN). For the communication there may be further requirements imposed by the field busses or other parts of the control system. In a preferred embodiment of the invention the communication technology used is based on the Bluetooth system. The fact that the range of a Bluetooth device is limited to around 10 m may be advantageous in environments with many radio devices or areas where it is very important to keep the radio interference levels as low as possible.

The communications from the instrument, a soft starter, a drive or drive controller via a data network also comprises a computer data signal. The computer data signal for configuration and/or control and/or operation of a motor controller, for example is arranged to provide control and soft starting to one or more electric motors embodied in a carrier wave. The data signal complies with one or more formats, for example internally formatted as an XML file, and includes means to identify the sending soft starter and the type of data such as number of starts, saved events, saved alarms, configured overload protection etc. for said motor controller.

The microprocessor (or processors) of the soft starter, device or instrument comprises at least one central processing unit CPU performing the steps of the method according to an aspect of the invention. This is performed with the aid of one or more computer programs, which are stored at least in part in memory accessible by the processor. It is to be understood that the computer programs may also be run on one or more general purpose industrial microprocessors or computers instead of a specially adapted computer.

The computer program comprises computer program code elements or software code portions that make the computer perform the method using equations, algorithms, data and calculations previously described. A part of the program may be stored in a processor as above, but also in a ROM, RAM, PROM EPROM or EEPROM chip or similar memory means. The program in part or in whole may also be stored on, or in, other suitable computer readable medium such as a magnetic disk, CD-ROM or DVD disk, hard disk, magneto-optical memory storage means, in volatile memory, in flash memory, as firmware, or stored on a data server. Removable memory media such as removable hard drives, bubble memory devices, flash memory devices and commercially available proprietary removable media such as the Sony memory stick and memory cards for digital cameras, video cameras and the like may also be used.

The computer programs described may also be arranged in part as a distributed application capable of running on several different computers or computer systems at more or less the same time.

In a yet further embodiment of the invention, the HMI may be embodied as a touch screen. In this case, text lines or images included in the display 4 of the preferred embodiment, and the select, navigation buttons 5a, b and 6a, b, may each be embodied as images on a touch screen. Configuration may be carried out according to the same method but executed by means of touching parts of the screen instead of pressing buttons, or by clicking with a computer mouse or other pointing/selection device.

The client applications of the HMI may be implemented as a thin client using a structured text document or file to present any of CIM/XML information, arguments, variables, addresses, links, mappable objects, executable applications or applets, or for example an HTML or other WWW based or HTML derivative protocol or XML protocol. The structured text document or file format takes care of handling graphical user display and activation functions of the HMI client. Activation functions refers to functions in the web page or web client display carried out by executable applications or applets which may be implemented as Java (TM) or similar. By means of such a thin client version of the HMI with an architecture such as described above, a user or a technician may examine status or data, configure a parameter, change set points and/or issue commands remotely in to any object for which he/she has authority to so do via the navigation interface.

1. A measuring instrument for measuring physical parameters of a flow, a temperature or a pressure meters in an industrial, commercial or electrical power application comprising a human-machine interface for control and configuration of said instrument, said human-machine interface comprising:
a visual display and selection means associated with said visual display,
means for presenting visually one or more functions of the instrument, and
selection means for selecting or increasing by increments a value displayed by the visual display.

2. The measuring instrument according to claim 1, wherein the selection means comprises means for selecting a setting or an option from one of two vertical positions.

3. The measuring instrument according to claim 1, wherein the selection means for selecting the one or more functions so displayed and/or navigating to another function or menu option select a value or action dependent on comprises a selection means for menu navigation or a selection means for selecting an operation and/or parameter or value.

4. The measuring instrument according to claim 1, wherein the selection means comprises means for selecting one of two or more selection means the function of each of which is dependent on the other information currently displayed by the display.

5. The measuring instrument according to claim 1, wherein the selection means comprises means for selecting an option to activate a menu in a position in the middle, lower part or in the upper part of the display.

6. The measuring instrument according to claim 1, wherein said measuring instrument comprises one or more data ports capable of serial data transmission.

7. The measuring instrument according to claim 1, wherein said measuring instrument comprises one or more connections for a field bus.

8. The measuring instrument according to claim 1, wherein said measuring instrument comprises one or more connections for a data network compatible with an Ethernet standard.

9. The measuring instrument according to claim 1, wherein said measuring instrument comprises a wireless node for wireless communication with the measuring instrument.

10. The measuring instrument according to claim 1, wherein said measuring instrument comprises a wireless node for wireless communication using wireless means such as a IR or Bluetooth equipped computer, mobile phone or PDA or other mobile computing device with the measuring instrument.

11. The measuring instrument according to claim 1, wherein said measuring instrument is operable by selecting an option by means of selecting a representation of a up selection button or a down selection button on a computer display screen of a computing device connected via a data port or field bus connection to said measuring instrument.

12. The measuring instrument according to claim 1, wherein said measuring instrument is arranged operable by selecting an option by means of selecting a representation of soft selection button on a computer display screen of a computing device connected via a data port or field bus connection.

13. The measuring instrument according to claim 1, wherein said measuring instrument comprises one or more memory means for processing data.

14. The measuring instrument according to claim 1, wherein said measuring instrument comprises one or more memory means for storing data from configuration and/or data from measurements and operations.

15. A method to configure a measuring instrument for measuring physical parameters of a flow, a temperature or a pressure meters in an industrial, commercial or electrical power application comprising a human-machine interface for control and configuration of said measuring instrument, the method comprising:
presenting one or more functions of said measuring instrument and one or more menu options on a visual display of said drive controller, and
selecting one of the one or more functions of said measuring instrument by activating a selection means of a plurality of selection means associated with the visual display to navigate or select a menu option, and/or activate a selection means to select an action or parameter or value.

16. The method according to claim 15, further comprising selecting a function or operation by activating either the up or down activation means.

17. The method according to claim 15, further comprising incrementing a value displayed on the visual display of a function or operation by activating either the up or down activation means.

18. The method according to claim 15, further comprising selecting an increased or decreased value by activating either the up or down navigation selection means.

19. The method according to claim 15, further comprising selecting one of the one or more menu options on a visual display by means of operating one of a plurality of selection means associated with the visual display.

20. The method according to claim 15, further comprising selecting one of the one or more menu options on a visual display by means of operating one of a plurality of selection means wherein the functionality of the soft buttons varies dependent on a state of the application displayed.

21. The method according to claim 15, further comprising selecting one of the one or more options on a visual display by means of operating one of a plurality of selection means wherein the functionality of the soft buttons is dependent on options currently shown on the visual display.

22. The method according to claim 15, further comprising selecting a value for a parameter via the visual display by means of operating or incrementing one of a plurality of selection means associated with the visual display.

23. The method according to claim 15, further comprising selecting an option by means of selecting a representation of a up selection button or a down selection button on a computer display screen of a computing device connected via a data port or field bus connection.

24. The method according to claim 15, further comprising selecting an option by means of selecting a representation of soft selection button on a computer display screen of a computing device connected via a data port or field bus connection.

25. The method according to claim 15, further comprising selecting an option by means of selecting one or more representations of a selection buttons on a computer display screen of a computing device connected to the drive controller in part via a wireless connection.

26. The method according to claim 15, further comprising selecting an option by means of selecting one or more representations of a selection button on a computer display screen of a mobile phone, PDA or other mobile computing device connected in part via a wireless connection.

27. The method according to claim 15, further comprising sending a data transmission using wireless communication means configured to operate according to a standard compatible issued by the Bluetooth Group.

28. Use of a measuring instrument for measuring physical parameters of a flow, a temperature or a pressure meters in an industrial, commercial or electrical power application according to claim 1, to measure a value for any from the list of: a flow, a temperature, a pressure.

29. A computer program comprising computer code means and/or software code portions for making a computer or processor perform any of the steps of claim 15.

30. The computer program product according to claim 29 comprised in one or more computer readable media.

31. A computer data signal for configuration of a measuring instrument, for measuring physical parameters of a flow, a temperature or a pressure meters in an industrial, commercial or electrical power application, embodied in a carrier wave, wherein the signal comprises one or more configured functions and/or measured values displayable on a display device of said measuring instrument.

32. The computer data signal according to claim 31, wherein said computer data signal is communicated by a short range wireless means according to a standard such as any of: Bluetooth, WLAN, WiFi, WiMax or similar.

33. A graphical user interface for a measuring instrument for measuring physical parameters of a flow, a temperature or a pressure meters in an industrial, commercial or electrical power application and for displaying configuration functions, menu options and parameter settings for a said measuring instrument, the interface comprising a visual display of menu options and/or measured values for a said measuring instrument and selection means arranged associated with said graphical user interface.

34. The graphical user interface according to claim 33, wherein a representation of the visual display of each said device and the selection means of each said device in a graphical user interface on a computer display screen of a computing device.

35. The graphical user interface according to claim 34, wherein the computing device may be a portable computing device comprising any from the list of: IR or Bluetooth equipped computer, mobile phone or PDA or other mobile computing device.

36. The graphical user interface according to claim 33, wherein the configuration data values displayed are arranged to be displayed upon activation of a part of the graphical representation of the visual display or selection means of each said device using a computer mouse, touch screen, stylus, keypad, keyboard or other computer display selection means.

37. A measuring instrument for measuring physical parameters of a flow, a temperature or a pressure meter in an industrial, commercial or electrical power application comprising a human-machine interface for control and configuration of said instrument, said human-machine interface comprising.
a visual display,
selection means associated with said visual display,
selection means for selecting or increasing by increments a value displayed by the visual display,
memory means for storing a configuration for an alarm or other parameter, an processor means, and
display means for presenting visually a value calculated by the processor means dependent on the configuration for an alarm or other parameter stored in the memory means.
